(19) United States
(12) Patent Application Publication
(10) Pub. No.: US 2009/0169702 A1
(43) Pub. Date: Jul. 2, 2009

(54) Cramonnaise- prepackaged mixture of mayonnaise and cranberry sauce

(76) Inventor: Patrick J. Kelleher, Monroe, NY (US)

Correspondence Address: Patrick J. Kelleher, 8 Sutherland Drive, Monroe, NY, 10950, US

(21) Appl. No.: 12/231,953

(22) Filed: Sep. 8, 2008

Related U.S. Application Data
(60) Provisional application No. 61/009,739, filed on Jan. 2, 2008.

(51) Int. Cl. A23L 1/39

(52) U.S. Cl. 426/589

(57) ABSTRACT

Two popular food items, mayonnaise and cranberry sauce, are mixed together to form a new food item which is to be called Cramonnaise. This new item is to be packaged and labeled with the new name—Cramonnaise. The name is derived from parts of the names of the ingredients, cranberry sauce and mayonnaise.

### CROSS-REFERENCE TO RELATED APPLICATIONS

There are no copending nonprovisional applications. There is, however, a provisional application for this product which was filed on Dec. 30, 2007 and which was granted on Jan. 22, 2008 and has the reference number U.S. 61/009,739.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The use of mayonnaise and cranberry sauce as separate food items has been common, especially around the holidays and with poultry leftovers. There is no known item on the wholesale or retail market and a patent search does not reveal that any prior applications have been submitted.

### BRIEF SUMMARY OF THE INVENTION

This invention very simply combines the two separate food items, mayonnaise and cranberry sauce, into one easily useable convenience food. It is called Cramonnaise, which name is to be considered part of the invention. The exact proportions of the products in the mixture can be adjusted based on market research after the initial product is patented and released for consumption.

### BRIEF DESCRIPTION OF THE SEVERAL VIEWS OF THE DRAWINGS

Not Applicable

### DETAILED DESCRIPTION OF THE INVENTION

Both Mayonnaise and Cranberry Sauce are common food items and are often used in combination. The combination of the two food items together, in different strengths, to satisfy various taste preferences, creates convenience to the private user and easily expands the ability of retailers to serve the taste needs of their customers. Cranberry sauce and mayonnaise are to be combined and packaged in a single container and called Cramonnaise. The product can then be easily and conveniently dispensed as needed.

1. This invention is specifically the combination and pre-packaging of the two food ingredients mayonnaise and cranberry sauce, in varying proportions according to market-determined preference, and is to be called Cramonnaise. Cramonnaise will provide an easily useable convenience food for those who wish to use both cranberry sauce and mayonnaise in the preparation of consumable food items.
